(19) United States
(12) Patent Application Publication
(10) Pub. No.: US 2025/0265159 A1
(43) Pub. Date: Aug. 21, 2025

(54) TECHNIQUE FOR MIGRATING A SNAPSHOT STORAGE SERVICE DURING A PLANNED FAILOVER EVENT

(71) Applicant: Nutanix, Inc., San Jose, CA (US)

(72) Inventors: Brajesh Kumar Shrivastava, Milpitas, CA (US); Angshuman Bezbaruah, Redmond, WA (US); Manan Shah, Newark, CA (US); Naveen Kumar, Bengaluru (IN); Prachi Gupta, Ghaziabad (IN); Pranab Patnaik, Cary, NC (US)

(21) Appl. No.: 19/181,123

(22) Filed: Apr. 16, 2025

Related U.S. Application Data
(63) Continuation-in-part of application No. 17/487,935, filed on Sep. 28, 2021.

(30) Foreign Application Priority Data
Sep. 6, 2024 (IN) 202441067483

(51) Int. Cl. G06F 11/20; G06F 11/16; G06F 16/16

(52) U.S. Cl. CPC G06F 11/203; G06F 11/1662; G06F 16/162

(57) ABSTRACT

A service migration technique moves (migrates) a snapshot storage service of an archival storage system from a primary site to a secondary site in accordance with a planned failover event. The snapshot storage service is configured to provide storage and retrieval of large amounts of snapshots (e.g., recovery points) of application workloads stored as objects on one or more buckets of an object store. As part of finalization of the recovery points (RPs) at the primary site, the snapshot storage service stores snapshot data and metadata of the RPs (e.g., as service state) in the object store. The snapshot storage service may then be migrated to the secondary site, wherein migration involves terminating the service at the primary site and instantiating the service at the secondary site. The instantiated storage service instance may then rebuild its service state from the object store, and resume storage and retrieval operations directed to RPs serviced by the instance.

### CROSS-REFERENCE TO RELATED APPLICATIONS

The present application is a continuation-in-part of U.S. patent application Ser. No. 17/487,935, which was filed on Sep. 28, 2021, by Abhishek Gupta, et al. for TECHNIQUE FOR EFFICIENTLY INDEXING DATA OF AN ARCHIVAL STORAGE SYSTEM, which claims the benefit of India Provisional Patent Application Serial No. 202141034114, which was filed on Jul. 29, 2021, by Abhishek Gupta, et al. for TECHNIQUE FOR EFFICIENTLY INDEXING DATA OF AN ARCHIVAL STORAGE SYSTEM, and also claims the benefit of India Provisional Patent Application Serial No. 202441067483, which was filed on Sep. 6, 2024, by Brajesh Kumar Shrivastava, et al. for TECHNIQUE FOR MIGRATING A SNAPSHOT STORAGE SERVICE DURING A PLANNED FAILOVER EVENT, which applications are hereby incorporated by reference.

The present application is related to U.S. patent application Ser. No. 18/826,953, filed on Sep. 6, 2024, by Brajesh Kumar Shrivastava et al, entitled TECHNIQUE FOR MANAGING MULTIPLE SNAPSHOT STORAGE SERVICE INSTANCES ON-DEMAND, and published on Dec. 26, 2024 as U.S. Publication No. 2024/0427733-A1, the contents of which are hereby incorporated by reference.

### BACKGROUND

### Technical Field

The present disclosure relates to archival of data and, more specifically, to migration of a snapshot storage service of an archival storage system.

### Background Information

File systems are not generally configured to maintain large quantities of point-in-time images or recovery points (i.e., snapshots) for long-term storage and retention in an archival storage system because they are primarily designed to rapidly apply changes (“live” data) to support immediate access requests. Accordingly, active file systems are often associated with backup/archival storage systems to make data of the snapshots immediately available for retrieval, e.g., to support critical restore operations.

Archival storage systems are generally organized based on object stores provided by public clouds and cloud service providers (CSPs), which are ubiquitous and may be accessed from anywhere in the world. Most object stores (e.g., AWS S3, Azure Blob, Nutanix Objects) also provide geographic replication (i.e., replication of data across servers in remote locations), thus making the data available and accessible, e.g., as objects, anywhere in the world. Often, the data may be snapshots of application workloads on the object provided by a snapshot storage service. Although configured primarily for archival of snapshots, the snapshot storage service may provide for data failover workflows and events from a primary site (e.g., an on-premises cluster) to a secondary site (e.g., a public cloud cluster), since the service enables preservation of snapshots for such workflows in the globally accessible public cloud object store. However, replicating data to an on-premises snapshot storage service from a workload running in the cloud cluster incurs substantial cloud egress costs as well as workload processing inefficiency.

### BRIEF DESCRIPTION OF THE DRA WINGS

The above and further advantages of the embodiments herein may be better understood by referring to the following description in conjunction with the accompanying drawings in which like reference numerals indicate identically or functionally similar elements, of which:

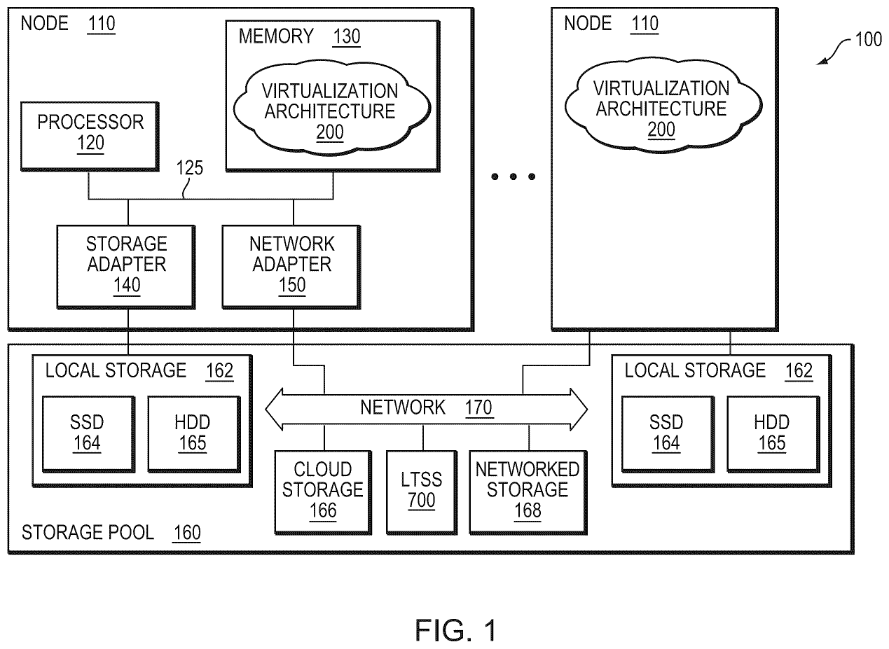

FIG. 1 is a block diagram of a plurality of nodes interconnected as a cluster in a virtualized environment;

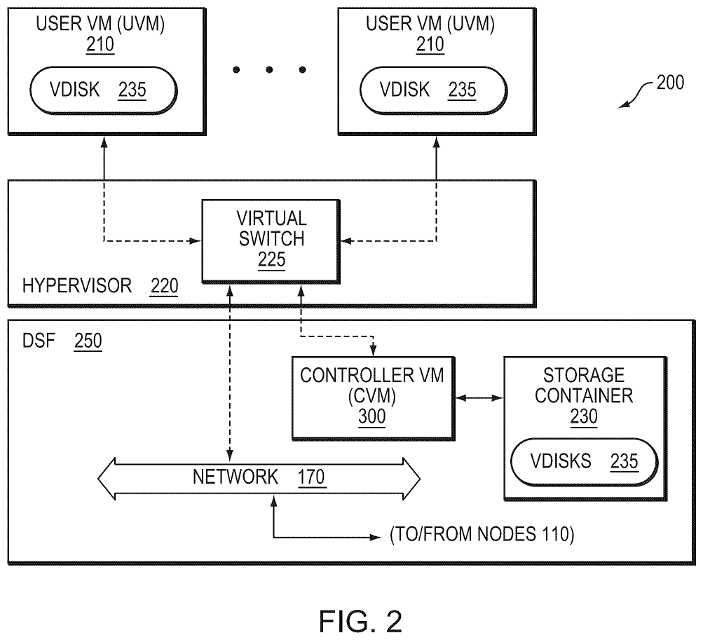

FIG. 2 is a block diagram of a virtualization architecture executing on a node to implement the virtualization environment;

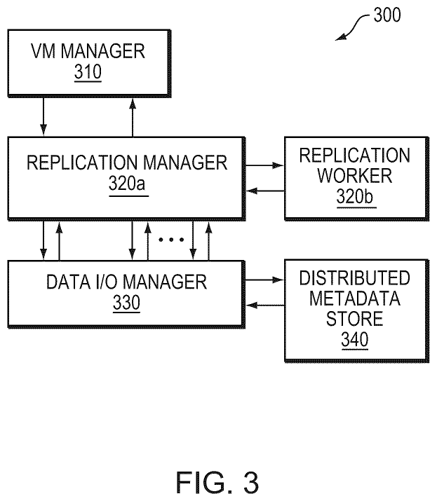

FIG. 3 is a block diagram of a controller virtual machine of the virtualization architecture;

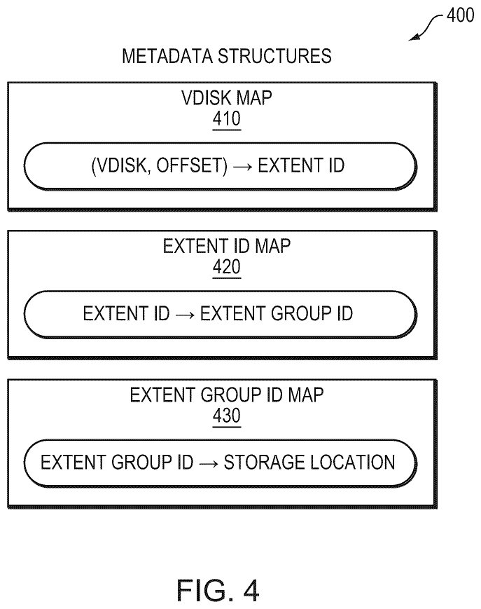

FIG. 4 is a block diagram of metadata structures used to map virtual disks (vdisks) of the virtualization architecture;

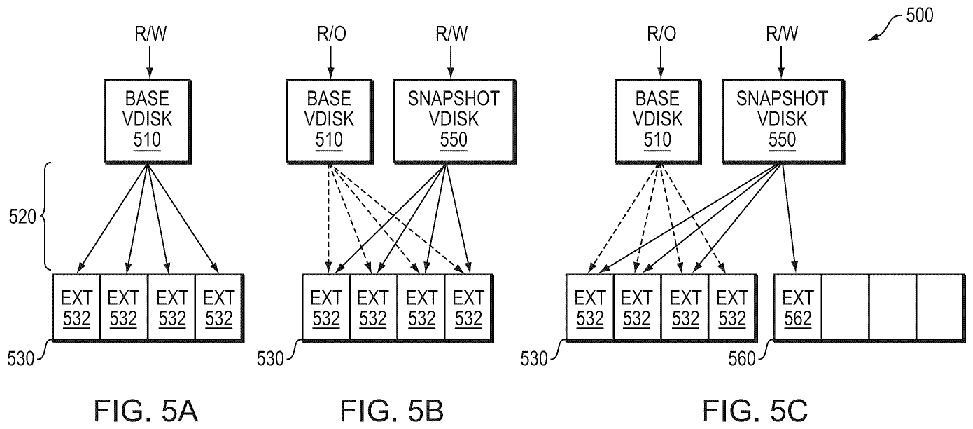

FIGS. 5A-5C are block diagrams of an exemplary mechanism used to create a snapshot of a vdisk;

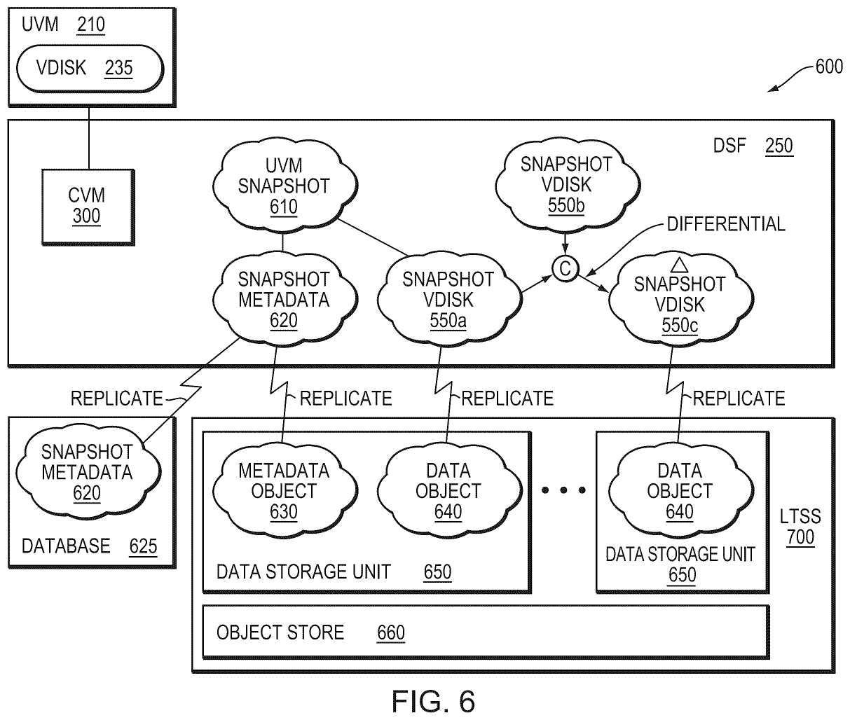

FIG. 6 is a block diagram of an exemplary data replication environment configured to replicate snapshots for storage to a long-term storage service (LTSS) of an archival storage system;

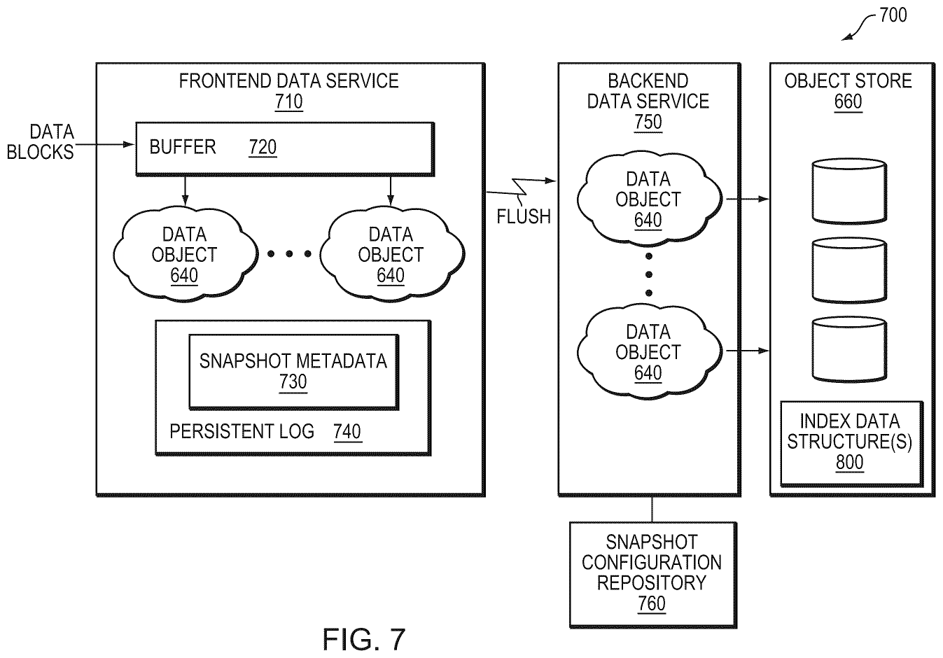

FIG. 7 is a block diagram of the LTSS of the archival storage system; and

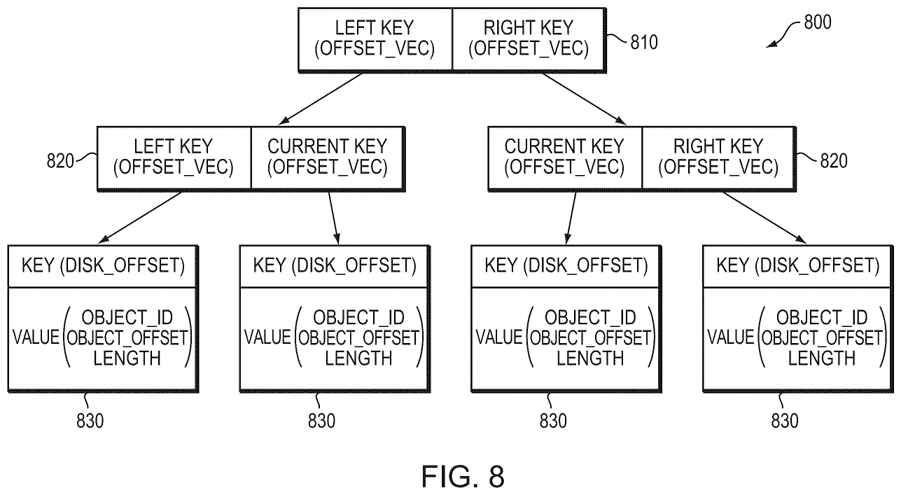

FIG. 8 is a block diagram illustrating an index data structure configured for efficient retrieval of snapshots from the LTSS of the archival storage system;

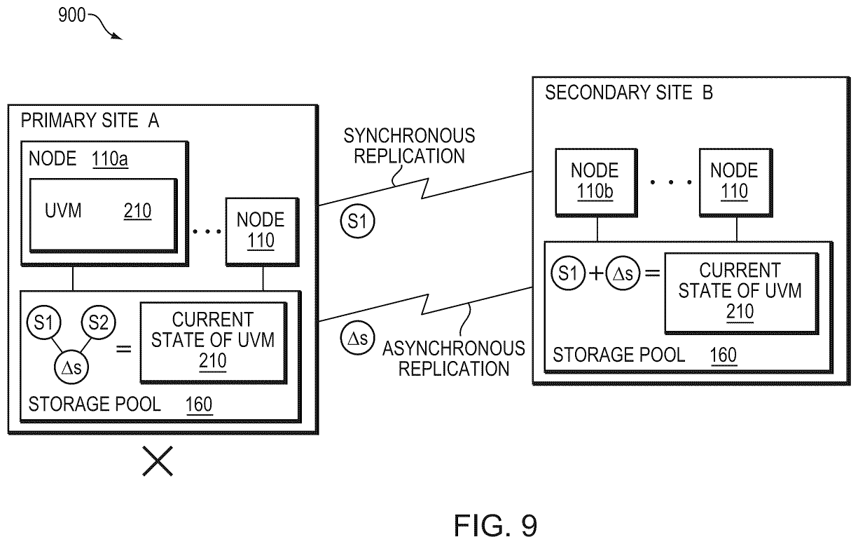

FIG. 9 is a block diagram of an exemplary data replication environment configured for use in various deployments, such as for disaster recovery;

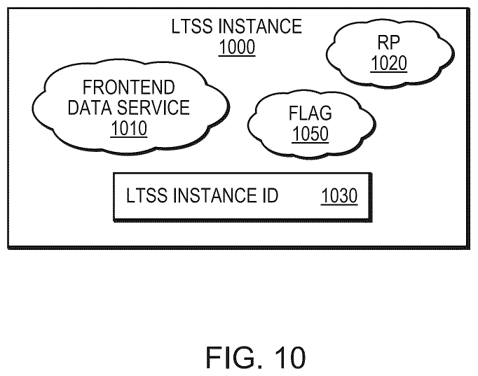

FIG. 10 is a block diagram of an embodiment of the LTSS as an LTSS instance of the archival storage system; and

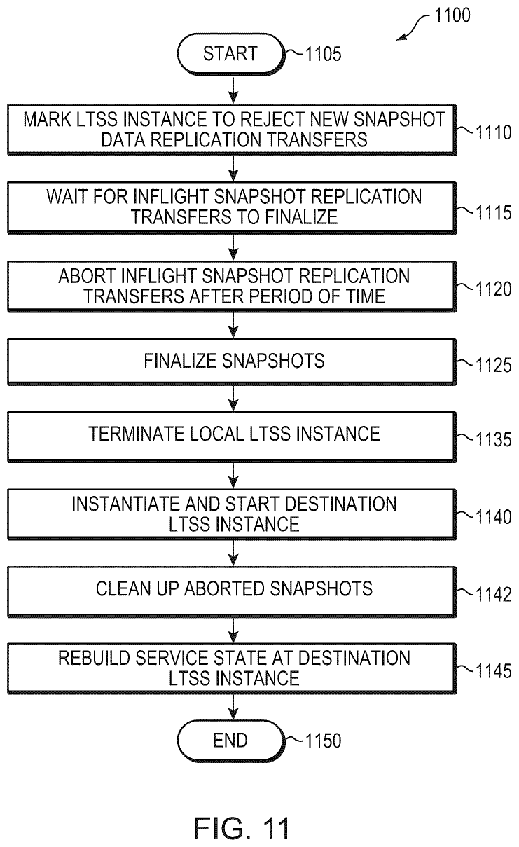

FIG. 11 is a flow chart of a service migration procedure for migrating an LTSS instance of an archival storage system from a primary site to a secondary site in accordance with a planned failover event.

### OVERVIEW

The embodiments described herein are directed to a service migration technique configured to move (migrate) a snapshot storage service of an archival storage system from a primary site to a secondary site in accordance with a failover event. The snapshot storage service is configured to provide storage and retrieval of large numbers (amounts) of point-in-time images or snapshots (e.g., recovery points) of application workloads stored as objects on one or more buckets of an object store. As part of finalization of the recovery points (RPs) at the primary site, the snapshot storage service stores snapshot data and metadata of the RPs (e.g., as a service state) in the object store. That is, the snapshot storage service acts a stateless server which may be re-instantiated to a same previously active state by retrieving the data and metadata in the object store. The snapshot storage service may then be migrated to the secondary site, wherein migration involves terminating the service at the primary site and instantiating (deploying) the service at the secondary site. The instantiated storage service (storage service instance) may then rebuild its service state from the object store, and resume storage and retrieval operations directed to RPs serviced by the instance. Notably, there is only one instance of the snapshot storage service running at a time at either the primary or secondary site serving a same set of RPs.

In an embodiment, the storage service instance may be embodied as a long-term storage service (LTSS) instance (a cloud agnostic snapshot storage service) configured to execute on one or more computer nodes (on-premises or in-cloud) to serve snapshots of recovery points (RPs) stored on the object store. Illustratively, the LTSS instance runs local to workload processing, e.g., at an on-premises cluster of the primary site. The LTSS instance receives replicated snapshots from a client in accordance with data replication transfers of a replication transaction. In response to a planned failover event, i.e., an event that initiates an orderly migration of workload processing from the primary site to the secondary site, e.g., a cloud cluster, all snapshots of RPs may be finalized and stored as objects in the object store. The technique provides a service migration procedure configured to migrate the LTSS instance (including index construction and management) from the primary site to the secondary site. The procedure is also configured to resolve data replication transfers that have not been completed, i.e., pending in-flight data (snapshot) replication transfers.

### DESCRIPTION

FIG. 1 is a block diagram of a plurality of nodes 110 interconnected as a logical group or cluster 100 and configured to provide compute and storage services for information, i.e., data and metadata, stored on storage devices of a virtualization environment. Each node 110 is illustratively embodied as a physical computer system (computer node) having hardware resources, such as one or more processors 120, main memory 130, one or more storage adapters 140, and one or more network adapters 150 coupled by an interconnect, such as a system bus 125. The storage adapter 140 may be configured to access information stored on storage devices, such as solid-state drives (SSDs) 164 and magnetic hard disk drives (HDDs) 165, which are organized as local storage 162 and virtualized within multiple tiers of storage as a unified storage pool 160, referred to as scale-out converged storage (SOCS) accessible cluster-wide. To that end, the storage adapter 140 may include input/output (I/O) interface circuitry that couples to the storage devices over an I/O interconnect arrangement, such as a conventional peripheral component interconnect (PCI) or serial ATA (SATA) topology.

The network adapter 150 connects the node 110 to other nodes 110 of the cluster 100 over network 170, which is illustratively an Ethernet local area network (LAN). The network adapter 150 may thus be embodied as a network interface card having the mechanical, electrical and signaling circuitry needed to connect the node 110 to the network 170. The multiple tiers of SOCS include storage that is accessible through the network 170, such as cloud storage 166 and/or networked storage 168, as well as the local storage 162 within or directly attached to the node 110 and managed as part of the storage pool 160 of storage objects, such as files and/or logical units (LUNs). The cloud and/or networked storage may be embodied as network attached storage (NAS) or storage area network (SAN) and include combinations of storage devices (e.g., SSDs and/or HDDs) from the storage pool 160. As described herein, a long-term storage service (LTSS 700) of an archival storage system provides storage of large numbers (amounts) of point-in-time images or recovery points (i.e., snapshots) of application workloads on an object store. Communication over the network 170 may be affected by exchanging discrete frames or packets of data according to protocols, such as the Transmission Control Protocol/Internet Protocol (TCP/IP) and the OpenID Connect (OIDC) protocol, although other protocols, such as the User Datagram Protocol (UDP) and the HyperText Transfer Protocol Secure (HTTPS), as well as specialized application program interfaces (APIs) may also be advantageously employed.

The main memory 130 includes a plurality of memory locations addressable by the processor 120 and/or adapters for storing software code (e.g., processes and/or services) and data structures associated with the embodiments described herein. The processor and adapters may, in turn, include processing elements and/or circuitry configured to execute the software code, such as virtualization software of virtualization architecture 200, and manipulate the data structures. As described herein, the virtualization architecture 200 enables each node 110 to execute (run) one or more virtual machines that write data to the unified storage pool 160 as if they were writing to a SAN. The virtualization environment provided by the virtualization architecture 200 relocates data closer to the virtual machines consuming the data by storing the data locally on the local storage 162 of the cluster 100 (if desired), resulting in higher performance at a lower cost. The virtualization environment can horizontally scale from a few nodes 110 to a large number of nodes, enabling organizations to scale their infrastructure as their needs grow.

It will be apparent to those skilled in the art that other types of processing elements and memory, including various computer-readable media, may be used to store and execute program instructions pertaining to the embodiments described herein. Also, while the embodiments herein are described in terms of software code, processes, and computer (e.g., application) programs stored in memory, alternative embodiments also include the code, processes and programs being embodied as logic, components, and/or modules consisting of hardware, software, firmware, or combinations thereof.

FIG. 2 is a block diagram of a virtualization architecture 200 executing on a node to implement the virtualization environment. Each node 110 of the cluster 100 includes software components that interact and cooperate with the hardware resources to implement virtualization. The software components include a hypervisor 220, which is a virtualization platform configured to mask low-level hardware operations from one or more guest operating systems executing in one or more user virtual machines (UVMs) 210 that run client software. The hypervisor 220 allocates the hardware resources dynamically and transparently to manage interactions between the underlying hardware and the UVMs 210. In an embodiment, the hypervisor 220 is illustratively the Nutanix Acropolis Hypervisor (AHV), although other types of hypervisors, such as the Xen hypervisor, Microsoft's Hyper-V, RedHat's KVM, and/or VMware's ESXi, may be used in accordance with the embodiments described herein.

Another software component running on each node 110 is a special virtual machine, called a controller virtual machine (CVM) 300, which functions as a virtual controller for SOCS. The CVMs 300 on the nodes 110 of the cluster 100 interact and cooperate to form a distributed system that manages all storage resources in the cluster. Illustratively, the CVMs and storage resources that they manage provide an abstraction of a distributed storage fabric (DSF) 250 that scales with the number of nodes 110 in the cluster 100 to provide cluster-wide distributed storage of data and access to the storage resources with data redundancy across the cluster. That is, unlike traditional NAS/SAN solutions that are limited to a small number of fixed controllers, the virtualization architecture 200 continues to scale as more nodes are added with data distributed across the storage resources of the cluster. As such, the cluster operates as a hyperconvergence architecture wherein the nodes provide both storage and computational resources available cluster wide.

The client software (e.g., applications) running in the UVMs 210 may access the DSF 250 using filesystem protocols, such as the network file system (NFS) protocol, the common internet file system (CIFS) protocol and the internet small computer system interface (iSCSI) protocol. Operations on these filesystem protocols are interposed at the hypervisor 220 and redirected (via virtual switch 225) to the CVM 300, which exports one or more iSCSI, CIFS, or NFS targets organized from the storage objects in the storage pool 160 of DSF 250 to appear as disks to the UVMs 210. These targets are virtualized, e.g., by software running on the CVMs, and exported as virtual disks (vdisks) 235 to the UVMs 210. In some embodiments, the vdisk is exposed via iSCSI, CIFS or NFS and is mounted as a virtual disk on the UVM 210. User data (including the guest operating systems) in the UVMs 210 reside on the vdisks 235 and operations on the vdisks are mapped to physical storage devices (SSDs and/or HDDs) located in DSF 250 of the cluster 100.

In an embodiment, the virtual switch 225 may be employed to enable I/O accesses from a UVM 210 to a storage device via a CVM 300 on the same or different node 110. The UVM 210 may issue the I/O accesses as a SCSI protocol request to the storage device. Illustratively, the hypervisor 220 intercepts the SCSI request and converts it to an iSCSI, CIFS, or NFS request as part of its hardware emulation layer. As previously noted, a virtual SCSI disk attached to the UVM 210 may be embodied as either an iSCSI LUN or a file served by an NFS or CIFS server. An iSCSI initiator, SMB/CIFS or NFS client software may be employed to convert the SCSI-formatted UVM request into an appropriate iSCSI, CIFS or NFS formatted request that can be processed by the CVM 300. As used herein, the terms iSCSI, CIFS and NFS may be interchangeably used to refer to an IP-based storage protocol used to communicate between the hypervisor 220 and the CVM 300. This approach obviates the need to individually reconfigure the software executing in the UVMs to directly operate with the IP-based storage protocol as the IP-based storage is transparently provided to the UVM.

For example, the IP-based storage protocol request may designate an IP address of a CVM 300 from which the UVM 210 desires I/O services. The IP-based storage protocol request may be sent from the UVM 210 to the virtual switch 225 within the hypervisor 220 configured to forward the request to a destination for servicing the request. If the request is intended to be processed by the CVM 300 within the same node as the UVM 210, then the IP-based storage protocol request is internally forwarded within the node to the CVM. The CVM 300 is configured and structured to properly interpret and process that request. Notably, the IP-based storage protocol request packets may remain in the node 110 when the communication—the request and the response—begins and ends within the hypervisor 220. In other embodiments, the IP-based storage protocol request may be routed by the virtual switch 225 to a CVM 300 on another node of the cluster 100 for processing. Specifically, the IP-based storage protocol request is forwarded by the virtual switch 225 to a physical switch (not shown) for transmission over network 170 to the other node. The virtual switch 225 within the hypervisor 220 on the other node then forwards the request to the CVM 300 on that node for further processing.

FIG. 3 is a block diagram of the controller virtual machine (CVM) 300 of the virtualization architecture 200. In one or more embodiments, the CVM 300 runs an operating system (e.g., the Acropolis operating system) that is a variant of the Linux® operating system, although other operating systems may also be used in accordance with the embodiments described herein. The CVM 300 functions as a distributed storage controller to manage storage and I/O activities within DSF 250 of the cluster 100. Illustratively, the CVM 300 runs as a virtual machine above the hypervisor 220 on each node and cooperates with other CVMs in the cluster to form the distributed system that manages the storage resources of the cluster, including the local storage 162, the networked storage 168, and the cloud storage 166. Since the CVMs run as virtual machines above the hypervisors and, thus, can be used in conjunction with any hypervisor from any virtualization vendor, the virtualization architecture 200 can be used and implemented within any virtual machine architecture, allowing the CVM to be hypervisor agnostic. The CVM 300 may therefore be used in a variety of different operating environments due to the broad interoperability of the industry standard IP-based storage protocols (e.g., iSCSI, CIFS, and NFS) supported by the CVM.

Illustratively, the CVM 300 includes a plurality of processes embodied as a storage stack running in a user space of the operating system of the CVM to provide storage and I/O management services within DSF 250. The processes include a virtual machine (VM) manager 310 configured to manage creation, deletion, addition and removal of virtual machines (such as UVMs 210) on a node 110 of the cluster 100. For example, if a UVM fails or crashes, the VM manager 310 may spawn another UVM 210 on the node. A replication manager 320a is configured to provide replication and disaster recovery capabilities of DSF 250. Such capabilities include migration/failover of virtual machines and containers, as well as scheduling of snapshots. In an embodiment, the replication manager 320a may interact with one or more replication workers 320b. A data I/O manager 330 is responsible for all data management and I/O operations in DSF 250 and provides a main interface to/from the hypervisor 220, e.g., via the IP-based storage protocols. Illustratively, the data I/O manager 330 presents a vdisk 235 to the UVM 210 in order to service I/O access requests by the UVM to the DFS. A distributed metadata store 340 stores and manages all metadata in the node/cluster, including metadata structures that store metadata used to locate (map) the actual content of vdisks on the storage devices of the cluster.

FIG. 4 is a block diagram of metadata structures 400 used to map virtual disks of the virtualization architecture. Each vdisk 235 corresponds to a virtual address space for storage exposed as a disk to the UVMs 210. Illustratively, the address space is divided into equal sized units called virtual blocks (vblocks). A vblock is a chunk of pre-determined storage, e.g., 1 MB, corresponding to a virtual address space of the vdisk that is used as the basis of metadata block map structures described herein. The data in each vblock is physically stored on a storage device in units called extents. Extents may be written/read/modified on a sub-extent basis (called a slice) for granularity and efficiency. A plurality of extents may be grouped together in a unit called an extent group. Each extent and extent group may be assigned a unique identifier (ID), referred to as an extent ID and extent group ID, respectively. An extent group is a unit of physical allocation that is stored as a file on the storage devices.

Illustratively, a first metadata structure embodied as a vdisk map 410 is used to logically map the vdisk address space for stored extents. Given a specified vdisk and offset, the logical vdisk map 410 may be used to identify a corresponding extent (represented by extent ID). A second metadata structure embodied as an extent ID map 420 is used to logically map an extent to an extent group. Given a specified extent ID, the logical extent ID map 420 may be used to identify a corresponding extent group containing the extent. A third metadata structure embodied as an extent group ID map 430 is used to map a specific physical storage location for the extent group. Given a specified extent group ID, the physical extent group ID map 430 may be used to identify information corresponding to the physical location of the extent group on the storage devices such as, for example, (1) an identifier of a storage device that stores the extent group, (2) a list of extent IDs corresponding to extents in that extent group, and (3) information about the extents, such as reference counts, checksums, and offset locations.

In an embodiment, CVM 300 and DSF 250 cooperate to provide support for snapshots, which are point-in-time copies of storage objects, such as files, LUNs and/or vdisks. FIGS. 5A-5C are block diagrams of an exemplary mechanism 500 used to create a snapshot of a virtual disk. Illustratively, the snapshot may be created by leveraging an efficient low overhead snapshot mechanism, such as the redirect-on-write algorithm. As shown in FIG. 5A, the vdisk (base vdisk 510) is originally marked read/write (R/W) and bas an associated block map 520, i.e., a metadata mapping with pointers that reference (point to) the extents 532 of an extent group 530 storing data of the vdisk on storage devices of DSF 250. Advantageously, associating a block map with a vdisk obviates traversal of a snapshot chain, as well as corresponding overhead (e.g., read latency) and performance impact.

To create the snapshot (FIG. 5B), another vdisk (snapshot vdisk 550) is created by sharing the block map 520 with the base vdisk 510. This feature of the low overhead snapshot mechanism enables creation of the snapshot vdisk 550 without the need to immediately copy the contents of the base vdisk 510. Notably, the snapshot mechanism uses redirect-on-write such that, from the UVM perspective, I/O accesses to the vdisk are redirected to the snapshot vdisk 550 which now becomes the (live) vdisk and the base vdisk 510 becomes the point-in-time copy, i.e., an “immutable snapshot,” of the vdisk data. The base vdisk 510 is then marked immutable, e.g., read-only (R/O), and the snapshot vdisk 550 is marked as mutable, e.g., read/write (R/W), to accommodate new writes and copying of data from the base vdisk to the snapshot vdisk. In an embodiment, the contents of the snapshot vdisk 550 may be populated at a later time using, e.g., a lazy copy procedure in which the contents of the base vdisk 510 are copied to the snapshot vdisk 550 over time. The lazy copy procedure may configure DSF 250 to wait until a period of light resource usage or activity to perform copying of existing data in the base vdisk. Note that each vdisk includes its own metadata structures 400 used to identify and locate extents owned by the vdisk.

Another procedure that may be employed to populate the snapshot vdisk 550 waits until there is a request to write (i.e., modify) data in the snapshot vdisk 550. Depending upon the type of requested write operation performed on the data, there may or may not be a need to perform copying of the existing data from the base vdisk 510 to the snapshot vdisk 550. For example, the requested write operation may completely or substantially overwrite the contents of a vblock in the snapshot vdisk 550 with new data. Since the existing data of the corresponding vblock in the base vdisk 510 will be overwritten, no copying of that existing data is needed and the new data may be written to the snapshot vdisk at an unoccupied location on the DSF storage (FIG. 5C). Here, the block map 520 of the snapshot vdisk 550 directly references a new extent 562 of a new extent group 560 storing the new data on storage devices of DSF 250. However, if the requested write operation only overwrites a small portion of the existing data in the base vdisk 510, the contents of the corresponding vblock in the base vdisk may be copied to the snapshot vdisk 550 and the new data of the write operation may be written to the snapshot vdisk to modify that portion of the copied vblock. A combination of these procedures may be employed to populate the data content of the snapshot vdisk.

The embodiments described herein are related to an indexing technique configured to provide an index data structure for efficient retrieval of data of a snapshot from the LTSS of the archival storage system. FIG. 6 is a block diagram of an exemplary data replication environment 600 configured to replicate snapshots for storage to the LTSS of the archival storage system. The architecture of LTSS 700 is configured to process large amounts of point-in-time images or recovery points (i.e., snapshots) of application workloads for storage on an object store 660 (archival storage vendor such as Amazon AWS S3 storage services, Google Cloud Storage, Microsoft Azure Cloud Storage and the like), wherein the workloads are characterized by a logical entity having typed data, e.g., a virtual machine (VM) such as a UVM 210. A client of LTSS 700 may be a distributed file system of a storage system (e.g., CVM 300 of DSF 250) that generates snapshots of the UVM (e.g., data processed by an application running in the UVM) and replicates the UVM snapshot 610 for storage in the object store 660. Replication, in this context, is directed to storage devices that exhibit incremental, block-level changes. LTSS 700 is thus a “generic” long-term storage service of an archival/backup storage system from the perspective of the client, i.e., the client flushes (delivers) data blocks of UVM snapshots 610 to the LTSS 700, which organizes the blocks for long-term storage in the object store 660. Each UVM snapshot 610 is generally handled as a data storage unit 650 by LTSS 700.

Illustratively, the content of each UVM snapshot 610 includes snapshot metadata and snapshot data, wherein the snapshot metadata 620 is essentially configuration information describing the logical entity (e.g., UVM 210) in terms of, e.g., virtual processor, memory, network and storage device resources of the UVM. The snapshot metadata 620 of the UVM 210 is illustratively replicated for storage in a query-able database 625 although, in an embodiment, the snapshot metadata 620 may be further replicated and organized as a metadata object 630 within a configuration namespace (e.g., bucket) of the object store 660 of LTSS 700 for long-term durability and availability. The data of the UVM 210 is virtualized as a disk (e.g., vdisk 235) and, upon generation of a snapshot, is processed as snapshot vdisk 550 of the UVM 210. The snapshot vdisk 550 is replicated, organized and arranged as one or more data objects 640 of the data storage unit 650 for storage in the object store 660. Each extent 532 of the snapshot vdisk 550 is a contiguous range of address space of a data object 640, wherein data blocks of the extents are “packed” into the data object 640 and accessible by, e.g., offsets and lengths. Note that a preferred size (e.g., 16 MB) of each data object 640 may be specified by the object store/vendor (e.g., AWS S3 cloud storage) for optimal use of the object store/vendor.

Operationally, the client initially generates a full snapshot of vdisk 235 (e.g., snapshot vdisk 550a) and transmits copies (i.e., replicas) of its data blocks to effectively replicate the snapshot vdisk 550a to LTSS 700. The snapshot vdisk 550a is thereafter used as a reference snapshot for comparison with one or more subsequent snapshots of the vdisk 235 (e.g., snapshot vdisk 550b) when computing incremental differences (deltas Δs). The client (e.g., CVM 300) generates the subsequent vdisk snapshots 550b at predetermined (periodic) time intervals and computes the deltas of these periodically generated snapshots with respect to the reference snapshot. The CVM 300 transmits replicas of data blocks of these deltas (delta replication) as Δ snapshot vdisk 550c to LTSS. From the perspective of the CVM 300, the LTSS 700 is a storage entity having an address on the network 170 (or WAN), similar to any networked storage 168. However, unlike networked storage 168, which is generally exposed to (accessed by) the CVM 300 using filesystem protocols such as NFS, CIFS and iSCSI, the LTSS 700 is accessed using specialized application program interfaces (APIs) referred to herein as replication APIs, which have rich descriptive semantics. For example, a replication API may specify the snapshotted vdisk 550a of the logical entity (e.g., UVM 210) as well as information describing the snapshot metadata 620 and snapshot vdisk 550a of the entity. The CVM 300 then transmits (replicates) a stream of data blocks of the snapshotted vdisk 550a to LTSS 700.

FIG. 7 is a block diagram of the LTSS 700 of the archival storage system. Illustratively, the LTSS 700 includes two data services (processes): a frontend data service 710 that cooperates with the client (e.g., CVM 300) to organize large amounts of the replicated snapshot data (data blocks) into data objects 640 and a backend data service 750 that provides an interface for storing the data objects 640 in the object store 660. In an embodiment, the LTSS data services/processes may execute on a computing platform at (or proximate) any location (or site) and is generally “stateless” as all data/metadata are stored on the object store 660. Accordingly, the frontend data service 710 and backend data service 750 may run either locally on a node of an “on-prem” cluster or remotely on a node of an “in-cloud” cluster. In response to receiving an initial replication API directed to the snapshot vdisk 550a, the frontend data service 710 temporarily stores the stream of data blocks of the snapshot vdisk 550a, e.g., in a buffer 720 and writes the data blocks into one or more extents (i.e., contiguous, non-overlapping, variable-length regions of the vdisk) for storage in data objects 640 of a preferred size (e.g., 16 MB) as specified by the object store vendor for optimal use. The frontend data service 710 then forwards (flushes) the data objects 640 to the backend data service 750 for storage in the object store 660 (e.g., AWS S3). In response to receiving a subsequent replication API directed to the Δ snapshot vdisk 550c, the frontend data service temporarily stores the stream of data blocks of the Δ snapshot vdisk 550c in buffer 720, writes those data blocks to one or more data objects 640, and flushes the objects to the backend data service 750.

Prior to flushing the data objects 640 to the backend data service 750, the frontend data service 710 creates metadata that keeps track of the amount of data blocks received from the CVM 300 for each replicated snapshot, e.g., snapshot vdisk 550a as well as Δ snapshot vdisk 550c. The metadata associated with the snapshot (i.e., snapshot metadata 730) is recorded as an entry in persistent storage media (e.g., a persistent log 740) local to the frontend data service 710. The snapshot metadata 730 includes information describing the snapshot data, e.g., a logical offset range of the snapshot vdisk 550. In an embodiment, the snapshot metadata 730 is stored as an entry of the persistent log 740 in a format such as, e.g., snapshot ID, logical offset range of snapshot data, logical offset into the data object to support storing multiple extents into a data object, and data object ID. The frontend data service 710 updates the snapshot metadata 730 of the log entry for each data object 640 flushed to the backend data service 750. Notably, the snapshot metadata 730 is used to construct the index data structure 800 of LTSS.

Illustratively, the index data structure 800 is configured to enable efficient identification (location) and retrieval of data blocks contained within numerous data objects 640 (snapshots) stored on the object store 660. Effectively, the index data structure acts as an independent database organized to retrieve data by extent of a vdisk (as recorded in the associated object store of the archival storage system) according to any snapshot. Notably, each snapshot is associated with a corresponding index data structure and may include incremental changes to a prior snapshot that may reference a prior index data structure associated with the prior snapshot. In this manner, only the incremental changes between snapshots need be stored in the archival storage system as indicated above, because later index data structures may reference (via prior index data structures) older blocks in prior snapshots.

Accordingly, the index data structure 800 may be extended to embody a plurality of “cloned,” e.g., copy-on-write, index structures associated with many of the data objects 640 of LTSS 700 to enable the location and retrieval of the data blocks. To that end, a snapshot configuration repository 760 (e.g., database) is provided, e.g., on storage media local to the LTSS data services, that is dynamically query-able by the data services to select a snapshot (i.e., the repository is organized according to snapshot) and its corresponding index data structure 800 of a data object, e.g., from among the numerous (cloned) index data structures. The repository 760 may also be stored on the object store 660 to ensure fault tolerance, durability and availability.

In an embodiment, the snapshot configuration repository 760 is organized as a key-value store that provides a higher-level of indexing (i.e., higher than the actual index data structure) to resolve to a snapshot corresponding to a (cloned) index data structure used to retrieve one or more data blocks for data objects stored in the object store 660. The snapshot configuration repository 760 is managed separately from the object store (e.g., remote from the object store media) and points to roots of the cloned index structures associated with snapshot data objects (e.g., using a remote referencing mechanism such as a URL to a root node of a cloned index structure resident on object store media located on the network/internet.) Such remote referencing enables essentially infinite storage capacity of the LTSS object store, e.g., among various cloud service providers (CSPs) such as AWS, Google, Azure and the like, that is not limited by an address space (file space, namespace) of a (client) distributed file system. Note that the limited address space of such client file systems also limits the amount of “active” file system snapshots that can be maintained on the client's storage (such as a volume).

In an embodiment, the snapshot configuration repository 760 may be used as a search engine to enable efficient locating and retrieving of a data block from the selected object. Similar to the persistent log 740, the snapshot configuration repository 760 includes configuration information about each snapshot and associated data object as well as pointers to the roots of the index data structures for the data objects. The repository 760 may also be indexed by time stamp or VM/vdisk name of a snapshot. The snapshot may then be selected and a pointer to a root node of the corresponding index data structure 800 may be identified to access a specified logical offset range of a snapshot. Notably, the index data structure 800 is configured to translate the logical offset range (address space) of data in the snapshot to the data object address space of the object store hosting the snapshot data to thereby enable efficient (i.e., bounded time) retrieval of the snapshot data from the object store independent of the number of snapshots.

FIG. 8 is a block diagram illustrating the index data structure 800 configured for efficient retrieval of snapshots from the LTSS of the archival storage system. In one or more embodiments, the index data structure 800 is illustratively a balanced tree (e.g., a B+ tree) with a large branching factor for internal nodes to maintain a limited depth of the tree, although other types of data structures, such as heaps and hashes, may be used with the embodiments described herein. When embodied as the B+ tree, the index data structure includes a root node 810, one or more intermediate (internal) nodes 820 and a plurality of leaf nodes 830. For the reference snapshot vdisk 550a, each internal node 820 contains a set of keys that specify logical offset ranges into the address space of the vdisk 550a and corresponding values that reference other nodes in the B+ tree (e.g., lower-level internal nodes or leaf nodes). Each leaf node 830 contains a value describing (pointing to) a data object having the extent that includes the selected data blocks corresponding to the specified logical offset range as well as a logical offset of the extent in the data object and length of the extent. In other words, a leaf node can be considered as a 4-tuple having: (i) a logical offset in the address space of the logical entity (e.g., snapshot), (ii) a data object id, (iii) a logical offset of the extent into the data object, and (iv) a length of the extent. The technique only requires traversing the depth of a (cloned) index data structure to find the leaf node 830 pointing to a selected data block of a particular snapshot (data object). Notably, a large branching factor (e.g., 1024) for internal nodes permits a very large number of references in the internal nodes 820 of the B+ tree so that a depth of the tree is reduced (e.g., to 2 or 3 levels) enabling an effective bounded traversal time from the root node to a leaf node (e.g., traverse at most 3 nodes to locate data in the object store). The address space covered by the leaf nodes is of variable length and depends upon a number of extents referenced according to the branching factor. In an embodiment, the internal nodes have a branching factor much larger than the leaf nodes to support a very large address space (e.g., given an extent size of less than 1 MB and a branching factor of 32K, a two-level B-tree can reference an address space as great as 16 exabytes).

In an embodiment, each internal node 820 contains keys and pointers to children nodes, and generally not any values. The root node 810 is a variant of the internal node 820 but, similar to the internal node, contains disk offsets as keys. For each key, a left pointer points to data of the vdisk ranging from a left key to (and including) a current key; illustratively, data in a “child” internal node 820 for the left pointer embodies the form [left key, current key]. A right pointer points to data of the vdisk ranging from the current key to (but excluding) a right key; illustratively, data in a child internal node for the right pointer embodies the form [current key, right key]. The fields of the internal node illustratively include (i) Offset_Vec containing a list of offsets in the vdisk that function as a key; and (ii) Child_Pointer_Vec containing a pointer to a child node. The leaf node 830 contains a predetermined number of descriptors (e.g., up to 1024), each of which describes the vdisk address space covered by the descriptor and the location of the corresponding data in the form of the following keys and values:

Key(Disk_Offset)→Value(Object_ID, Object_Logical_Offset, Length)

wherein Disk_Offset refers to the offset within the vdisk; Object_ID identifies the data object in the archival storage system and may be a combination of a vdisk uuid and an assigned predefined (int64) number; Object_Logical_Offset is the logical offset with the object (specified by Object_ID) at which the data resides; and Length is the number of contiguous bytes (size of the extent) beginning at “Offset” (Disk_Offset) that is pointed to by the key entry.

Referring to FIG. 6, assume the CVM 300 generates the reference snapshot as snapshot vdisk 550a for vdisk 235 and having a size of 1 TB with an assigned a vdisk ID of, e.g., 1. The CVM 300 replicates the data blocks of the snapshot vdisk 550a to the LTSS 700 in accordance with a first replication API call that identifies the vdisk ID 1 and the snapshot vdisk 550a as, e.g., snapshot ID 1. In response to receiving the first replication API call, the frontend data service 710 “buffers” the changed data blocks to an optimal size (e.g., 16 MB) and writes the blocks into a plurality of (“n”) data objects 640 assigned, e.g., data object IDs 1-n. The frontend data service 710 also records snapshot metadata 730 describing the written data blocks (e.g., vdisk ID 1, snapshot ID 1, logical offset range 0-1 TB, data object IDs 1a-n) to the persistent log 740. After all of the data blocks are replicated and flushed to the object store 660, the frontend data service 710 constructs one or more index data structures 800 for the snapshot vdisk 550a (i.e., a parent B+ tree) using the appropriate snapshot metadata 730 for snapshot ID 1.

Assume that at the predetermined time interval, the CVM 300 generates a subsequent snapshot for the vdisk 235 (e.g., snapshot vdisk 550b) and after specifying snapshot 550a as a reference snapshot and performing the incremental computation, determines that the deltas (changes) of data blocks between the snapshot vdisks 550a,b lie in the offset range of 1 MB-5 MB and 1 GB-2 GB of the reference snapshot (e.g., snapshot vdisk 550a). Such deltas may be determined for a series of snapshots. For example, the CVM 300 may issue a second replication API call to the LTSS 700 that identifies the vdisk ID 1, a first snapshot vdisk 550b as, e.g., snapshot ID 2, and the logical offset range of 1 MB-5 MB for the changed data blocks. The CVM 300 then replicates the delta data blocks to the LTSS 700. In response to receiving the second replication API call, the frontend data service 710 buffers the changed data blocks to an optimal size (e.g., 16 MB) and writes the blocks into a data object 640 assigned, e.g., an object ID 2. The frontend data service 710 also records snapshot metadata 730 describing the written data blocks (e.g., vdisk ID 1, snapshot ID 2, logical offset range 1 MB-5 MB, object ID 2) to the persistent log 740.

After all of the changed data blocks are replicated and flushed to the object store 660, the frontend data service 710 constructs an index data structure 800 for the first snapshot vdisk 550b using the appropriate snapshot metadata 730 for snapshot ID 2. Assume the changed data blocks at the logical offset range 1 MB-5 MB of the snapshot vdisk 550a fit within the data object (extent) referenced by a leaf node 830 of the parent B+ tree. A new, updated copy of the leaf node may be created to reflect the changed data blocks at the logical offset range while the remaining leaf nodes of the parent B+ tree remain undisturbed. Updated copies of the internal node(s) 820 referencing the logical offset range of the changed data blocks described by the updated leaf node may likewise be created. A new “cloned” B+ tree is thus constructed based on the parent B+ tree using a copy-on-write technique. The cloned B+ tree has a new root node 810a and internal nodes 820 that point partially to “old” leaf nodes 830 of the parent B+ tree as well as to the new leaf node 830a (not shown). Illustratively, the leaf node 830a is copied and then modified to reference the changed data. Effectively, the cloned B+ tree for the first Δ snapshot vdisk 550c is a “first child” B+ tree that shares internal and leaf nodes with the parent B+ tree.

The CVM 300 thereafter issues a third replication API call to the LTSS 700 that identifies the vdisk ID 1, a second Δ snapshot vdisk 550c as, e.g., snapshot ID 3, and the logical offset range of 1 GB-2 GB for the changed data blocks. The CVM 300 replicates the delta data blocks to the LTSS 700. In response to receiving the third replication API call, the frontend data service 710 buffers the changed data blocks to an optimal size (e.g., 16 MB) and writes the blocks into “n” data objects 640 assigned, e.g., object IDs 3a-n (not shown). The frontend data service 710 records snapshot metadata 730 describing the written data blocks (e.g., vdisk ID 1, snapshot ID 3, logical offset range 1 GB-2 GB, object IDs 3a-n) to the persistent log 740. After all of the changed data blocks are replicated and flushed to the object store 660, the frontend data service 710 constructs one or more second child B+ trees for the second A snapshot vdisk, as described above. Notably, a large branch factor of the B+ tree permits a very large number of references in the internal nodes of the B+ tree to support a correspondingly large number of changes between snapshots so that the index structure depth of the tree may be maintained at a maximum depth (e.g., 2 to 3 levels) enabling rapid traversal time from the root node to a leaf node. That is, no matter how many snapshots exist, references to the oldest data remain referenced by the newest snapshot resulting in a fixed number of node traversals to locate any data.

Operationally, retrieval of data blocks (snapshot data) by the LTSS data services from any snapshot stored in the archival storage system involves fetching the root of the index (B+ tree) data structure 800 associated with the snapshot from the snapshot configuration repository 760, using the offset/range as a key to traverse the tree to the appropriate leaf node 830, which points to the location of the data blocks in the data object 640 of the object store 660. For incremental restoration of snapshot data, the technique further enables efficient computation of differences (deltas) between any two snapshots. In an embodiment, the LTSS data services perform the delta computations by accessing the snapshot configuration repository 760, identifying the root nodes 810 of the corresponding index data structures 800 (e.g., B+ trees) for the two snapshots, and traversing their internal nodes 820 all the way to the leaf nodes 830 of the index data structures to determine any commonality/overlap of values. All leaf nodes 830 that are common to the B+ trees are eliminated, leaving the non-intersecting leaf nodes corresponding to the snapshots. According to the technique, the leaf nodes of each tree are traversed to obtain a set of <logical offset, object ID, object offset> tuples and these tuples are compared to identify the different (delta) logical offset ranges between the two snapshots. These deltas are then accessed from the data objects and provided to a requesting client.

Previous deployments of index data structures employing B+ trees are generally directed to primary I/O streams associated with snapshots/clones of active file systems having changeable (mutable) data. In contrast, the technique described herein deploys the B+ tree as an index data structure 800 that cooperates with LTSS 700 for long-term storage of large quantities of typed snapshot data treated as immutable and, further, optimizes the construction of the B+ tree to provide efficiencies with respect to retrieval of data blocks contained in large quantities of long-term storage data objects 640. For example, the technique imposes transactional guarantees associated with a client-server model to facilitate construction of the index data structure 800 in local storage of LTSS 700 prior to transmission (flushing) to the object store 660. Upon initiation of a transaction to replicate snapshot data (e.g., snapshot vdisk 550a or Δ snapshot vdisk 550c), a client (e.g., CVM 300) may issue a start replication command that instructs a server (e.g., frontend data service 710 of LTSS 700) to organize the data as extents for storage into one or more data objects 640. In an embodiment, the frontend data service 710 receives one or more snapshots replicated by the client in accordance with one or more data (snapshot) replication transfers of a replication transaction over a multi-step, transactional replication protocol. Data blocks of the object 640 are flushed to the backend data service 750 for storage on the object store 660. Subsequently, the CVM 300 may issue a complete replication command to the frontend data service 710 which, in response, finalizes the snapshot (e.g., of recovery points) by using information from snapshot metadata 730 to construct the index data structure 800 associated with the data object locally, e.g., in a fast storage tier of LTSS 700 and, in one or more embodiments, flushing the constructed index structure 800 to the backend data service for storage on the object store 660. Note that the transactional guarantees provided by the optimized technique allow termination of the replication and, accordingly, termination of construction of the index data structure prior to finalization.

In essence, the technique optimizes the use of an index data structure (e.g., B+ tree) for referencing data recorded in a transactional archival storage system (e.g., LTSS) that has frontend and backend data services configured to provide transactional guarantees that ensures finalization of snapshot replication only after the client (e.g., CVM) indicates completion of the transaction. Until issuance of the completion command, the replication (or backup) transaction can be terminated. This enables construction of a (cloned) index data structure for each replicated snapshot on high performance (fast) storage media of an LTSS storage tier that may be different from the storage media tier used for long-term storage of the index data structure 800 and data object 640. Note that active file system deployments of the B+ tree as an index data structure are constrained from applying such a transactional model to write operations (writes) issued by a client (e.g., user application) because those writes are immediately applied to the active file system (e.g., as “live” data) to support immediate access to the data and preserved in the B+ tree index structure unconditionally (i.e., writes in the index structure cannot be ignored or terminated as in transactional models). Moreover, conventional backup systems associated with active file systems also require that the writes of the snapshot data be immediately available for retrieval without delay to support immediate availability of restore operations. In contrast, the LTSS architecture is optimized for storing immutable typed snapshot data not shared with an active (mutable) file system and not live data for active file systems or conventional backup systems.

In other words, after the replication complete command, the metadata associated with the stream of snapshot data is processed to construct the index data structure (e.g., a B+ tree) at the frontend data service 710 and flushed to the backend data service 750 for storage in the object store 660. This optimization is advantageous because object stores are generally immutable repositories consisting of low-performance (slow) storage media that are not generally suited for constructing changing and frequently accessed data structures that require constant iteration and modification (mutation) during construction. The technique thus enables construction of the B+ tree index structure locally on a fast storage media tier of the LTSS 700 before flushing the completed index data structure 800 to the object store 660. The fast, local storage media used to persistently store the metadata and construct the index data structure may be SSD or HDD storage devices that are separate and apart from the storage devices used by the object store 660.

The LTSS 700 is thus agnostic as to the file system (client) delivering the data and its organization, as well as to the object store storing the data. By implementing a transactional model for data replication by the data services of LTSS 700, the technique further enables deferred construction of a (cloned) index data structure 800 locally on fast storage media (e.g., on-prem) upon transaction completion (e.g., a backup commit command), and subsequent flushing of a completed index data structure to the remote object store 660 of LTSS (e.g., in-cloud). Deferral of construction of the index data structure enables fast intake (i.e., reception) of the replicated snapshot data in a log-structured (e.g., sequential order) format while the snapshot metadata is recorded in the persistent log by the frontend data service. The data services of LTSS 700 perform optimal organization and packing of the data as extents into data objects 640 as defined by the object store vendor/CSP. Notably, the technique described herein facilitates efficient storage and retrieval of the data objects using an indexing data structure 800 that is optimized to accommodate very large quantities of snapshots (e.g., many thousand over a period of years), while managing metadata overhead that grows linearly with the increase of data changes and not with the number of snapshots.

For pure archival storage, a log-structured approach may be preferred because primarily writes (only occasionally reads) are performed to storage. Yet for archival storage where data is frequently retrieved, e.g., for compliance purposes in medical and SEC regulation deployments, a B+ tree structure may be preferred. This latter approach is particularly attractive when the B+ tree is optimized to handle frequent “read-heavy” and “write-heavy” workloads. As described herein, the technique balances the trade-off such that the cost of creating the index structure is realized later, i.e., not in the context of incoming I/O writes, by deferring work from the critical path/time so as to avoid adding latency that typically occurs creating pure B+ tree structures. Therefore, the technique also provides an efficient indexing arrangement that leverages a write-heavy feature of the log-structured format to increase write throughput to the LTSS 700 for snapshot data replication to the object store 660 with a read-heavy feature of the index (e.g., B+ tree) data structure 800 to improve read latency (i.e., bounded time to locate data independent of the number of snapshots) by the LTSS 700 for snapshot data retrieval from the object store 660.

Illustratively, the indexing technique is optimized to support extended-length block chains of snapshots (i.e., “infinite-depth” snapshot chains) for long-term storage in the object store of the archival storage system. A problem with such deep snapshot chains is that a typical search for a selected data block of a snapshot requires traversing the entire snapshot chain until the block is located. The indexing technique obviates such snapshot chain traversal by providing an index data structure 800 (e.g., B+ tree) that is cloned for each snapshot (e.g., snapshot disk 550a,b) of a logical entity (e.g., vdisk 235) using copy-on-write that enables sharing references to data blocks with other cloned index data structures, as described herein. As also noted, the technique only requires traversing the depth of a (cloned) index data structure to find the leaf node pointing to a selected data block of a particular snapshot.

As described herein, a long-term storage service, such as LTSS 700, that provides storage of large numbers (amounts) of snapshots on the object store 660 may be employed to store and retrieve snapshots from an object store. Although configured primarily for archival of snapshots, an LTSS service may be implemented as a building block for certain data failover workflows and events since the service enables preservation of snapshots for such workflows in the globally accessible public cloud object store. Data failover generally involves copying or replicating data among one or more nodes 110 of clusters 100 embodied as, e.g., datacenters to enable continued operation of data processing operations in a data replication environment, such as backup, content distribution and disaster recovery. The data replication environment typically includes two or more datacenters, i.e., sites, which are typically geographically separated by large distances and connected over a communication network, such as a WAN. For example, data at a local datacenter (primary site) may be replicated over the network to a remote datacenter (secondary site) located at a geographically separated distance to ensure continued data processing operations in the event of a failure of the node(s) at the primary site.

FIG. 9 is a block diagram of an exemplary data replication environment configured for use in various deployments, such as for backup, content distribution and/or disaster recovery (DR). Illustratively, the environment 900 includes two sites: primary site A and secondary site B, wherein each site represents a datacenter embodied as a cluster 100 having one or more nodes 110. A logical entity (e.g., one or more UVMs 210) running on primary node 110a at primary site A is designated for failover to secondary site B (e.g., secondary node 110b) in the event of failure of primary site A. A first snapshot S1 of data of the logical entity is generated at the primary site A and replicated (e.g., via synchronous replication) to secondary site B as a base or “common” snapshot S1. A period of time later, a second snapshot S2 may be generated at primary site A to reflect a current state of the data (e.g., UVM 210). Since the common snapshot S1 exists at sites A and B, only incremental changes (deltas Δs) to the data designated for failover need be sent (e.g., via asynchronous replication) to site B, which applies the deltas (Δs) to S1 so as to synchronize the state of the UVM 210 to the time of the snapshot S2 at the primary site. A tolerance of how long before data loss will exceed what is acceptable determines (i.e., imposes) a frequency of snapshots and replication of deltas to failover sites, e.g., a data loss tolerance of one hour (60 mins) requires snapshots with commensurate delta replication every 60 mins—deemed a Recovery Point Objective (RPO) of 60 minutes.

In an embodiment, a failover event may be an unplanned failover event caused by an unexpected disaster (such as an unforeseen catastrophic occurrence resulting in a power failure) that results in a hastened migration of data processing operations from a primary site to a secondary site. In contrast, a planned failover event (such as a foreseen occurrence that may result in a power failure) may involve an orderly migration of those operations. It is generally desirable to run the LTSS service at the primary site (e.g., on-premises cluster) to reduce CSP service costs associated with running the service at the secondary site (e.g., public cloud cluster) close to the object store. However, if an administrator plans to migrate the workload to the public cloud cluster in accordance with a planned failover event, it may also be desirable to migrate the LTSS service, because a workload that is running in cloud cluster and replicating data to an on-premises LTSS service will incur substantial data egress cost by the CSP hosting the cloud cluster. In addition, for a planned failover to a remote site (e.g., another on-premises site), it is desirable to also migrate the LTSS service nearer the remote site to ensure colocation with the workload for efficiency purposes, i.e., lower latency and better throughput by the LTSS service.

The embodiments described herein are directed to a service migration technique configured to move (migrate) a snapshot storage service of an archival storage system from a primary site (e.g., an on-premises cluster) to a secondary site (e.g., a public cloud cluster) in accordance with a failover event. The snapshot storage service, such as LTSS, is configured to provide storage and retrieval of large numbers (amounts) of point-in-time images or snapshots (e.g., recovery points) of application workloads stored as objects on one or more buckets of an object store. As part of finalization of the recovery points (RPs) at the primary site, the snapshot storage service stores data and metadata of the RPs (e.g., as service state) in the object store. That is, the snapshot storage service acts a stateless server which may be re-instantiated to a same previously active state by retrieving the data and metadata in the object store. The snapshot storage service may then be migrated to the secondary site, wherein migration involves terminating the service at the primary site and instantiating (deploying) the service at the secondary site. The instantiated snapshot storage service (storage service instance) may then rebuild its service state from the object store, and resume storage and retrieval operations directed to RPs serviced by the instance. Notably, there is only one instance of the storage service running at a time at either the primary or secondary site serving a same set of RPs.

In an embodiment, the snapshot storage service instance may be embodied as an LTSS instance configured to execute on one or more computer nodes to serve snapshots of recovery points (RPs) stored on the object store, which may be part of cloud storage 166. FIG. 10 is a block diagram of an embodiment of the LTSS as an LTSS instance 1000 of the archival storage system. Every LTSS instance 1000 has an identifier (ID) which is illustratively a universally unique ID (UUID). Each LTSS instance 1000 that creates a snapshot object (snapshot) also stamps (marks or records metadata storing the instance ID associated with the object) the snapshot with the LTSS instance ID 1030 as an owner of the object. Each LTSS instance 1000 may be terminated and re-instantiated (re-created) in the same or different availability zone at the same or different time illustratively in accordance with administrative driven operations or commands. As used herein, an availability zone is a logical boundary for a group of managed computer nodes deployed in one or more geographical locations. An LTSS instance 1000 that terminates and instantiates (deploys) in a different availability zone can easily detect its owned snapshot objects (e.g., via the LTSS instance ID 1030) and resume operation on those snapshots.

In an embodiment, the LTSS instance 1000 runs local to workload processing, e.g., at an on-premises cluster of a primary site. A client (e.g., CVM 300) replicates the workload (data and metadata) as snapshots of a RP 1020 to the LTSS instance 1000, which finalizes the RP snapshots and stores them as objects (e.g., data objects 640) on an object store (e.g., object store 660) of a CSP. The LTSS instance 1000 receives the replicated snapshots from the client as data replication transfers of a replication transaction. Snapshot data of the replication transfers are organized as data objects 640 and stored on the object store 660. However, snapshot metadata 730 associated with the replicated snapshots is retained locally at the LTSS instance and used to finalize the snapshots of RPs 1020 by constructing index data structures (indexes) for the snapshots replicated to the object store, which index data structures are also stored in the object store upon finalization of the RPs. Thus, if the LTSS instance 1000 unexpectedly terminates (fails or shuts down), all un-finalized snapshots/RPs may be lost because indexes for those snapshots were not completed and stored on the object store (e.g., as state of the LTSS instance).

Assume a planned failover event occurs, wherein the planned failover event is an event that initiates (triggers) an orderly movement (migration) of partial (or entire) workload processing from primary site A to secondary site B, e.g., a cloud cluster of the CSP, in accordance with data replication environment 900. As part of the orderly migration, all snapshots of RPs 1020 may be finalized such that snapshot data and metadata are stored as objects in the object store 660. The technique described herein provides a service migration procedure configured to migrate the LTSS instance 1000 (including index construction and management) from the primary site A to the secondary site B. In an embodiment, the LTSS instance 1000 may be “stateless” since the migrated LTSS instance can rebuild its service state from the snapshot data and metadata stored in the object store 660. However, a challenge involves data (snapshot) replication transfers that have not been completed, i.e., pending in-flight snapshot replication transfers and incomplete associated index data structures.

As replicated snapshots are received from the client, the LTSS instance 1000 organizes the snapshot data as data objects 640 and stores them in the object store 660. However, indexing information (e.g., snapshot metadata 730) describing the replicated snapshot is maintained (retained) in a local store (e.g., persistent log 740) that is local to the LTSS instance. An example of indexing information that describes the replicated snapshot includes (i) an identifier (ID) of the replicated snapshot (e.g., snapshot1); (ii) offset and range of snapshot data in the data object (e.g., offset range 1 GB-1.5 GB); and ID of data object storing the data (e.g., data object1). The indexing information is maintained locally at the LTSS service and is used to construct the index data structure 800 for the replicated snapshot (e.g., snapshot1). The constructed index is then stored (flushed) to the object store as a metadata object.

In an embodiment, the LTSS instance 1000 receives one or more snapshots replicated by the client in accordance with one or more data replication transfers of a replication transaction over a multi-step, transactional replication protocol embodied as specialized replication APIs. The replication APIs have defined semantics for transfer and completion of a specified logical entity (e.g., VM and/or vdisk) being snapshotted as well as metadata (e.g., indexing information) describing the snapshot data (e.g., of vdisk) for retrieval from the object store. Illustratively, the replication APIs include commands such as (i) a start replication command that instructs the LTSS instance to organize the snapshot data of the replicated snapshots as extents for storage as data objects 640 in the object store 660, and (ii) a complete replication command that finalizes the replicated snapshots using the indexing information to construct index data structures (indexes) for efficient retrieval of data from the snapshots and flushes (stores) the indexes to the object store. Notably, the transactional replication protocol is configured to facilitate deferred construction of the indexes.

In an embodiment, the steps of the multi-step replication protocol include an initiate replication step wherein the LTSS instance 1000 receives snapshot data (blocks) and indexing information from a client and stores the snapshot data blocks as objects in the object store. The indexing information is maintained in fast, randomly accessible persistent storage media (e.g., persistent log 740) that is local to the LTSS instance. In accordance with a complete (finalization) replication step, the LTSS instance 1000 finalizes and stores (commits) the snapshot on the object store and completes the replication transaction. The actual index construction is performed as part of the finalization step and the constructed index is stored in the object store 660. Any replication transfers that abort (fail to complete) are discarded and partially replicated snapshots are deleted (e.g., removed by garbage collection).

Migration of the LTSS instance 1000 may result in loss of any inflight replications as an instantiated (created) LTSS service in a different location (e.g., the public cloud) may lose the indexing information stored in the local store used to find finalized and stored (committed) snapshots in the object store 660. Accordingly, the technique described herein introduces a “quiesce and drain” phase of a service migration procedure, where any new incoming data replication transfers from clients are blocked and any inflight data replication transfers are allowed to complete. In order to avoid blocking due to slow (or dead) clients, the LTSS instance 1000 may introduce timeouts.

FIG. 11 is a flow chart of a service migration procedure 1100 for migrating an LTSS instance of an archival storage system from a primary site to a secondary site in accordance with a planned failover event. In an embodiment, the following steps of the service migration procedure 1100 are illustratively performed by a frontend data service 1010 (e.g., similar to frontend data service 710) of the LTSS instance 1000, although it is known to persons of skill in the art that the procedure may be performed by other arrangement services. The procedure starts at 1105 and proceeds to the quiesce and drain phase of the procedure as follows:
1. At box 1110, mark the LTSS service (instance) to cease generation of new snapshots from one or more clients.
2. At box 1115, wait for all ongoing (pending) inflight snapshot replication transfers to complete (finalize) or abort.
3. At box 1120 abort pending inflight snapshot replication transfers after elapse of configurable period of time (timeout period). In an embodiment, clients are expected to send “finalize” requests (e.g., complete replication commands) for all inflight replications within the timeout period. Snapshots/replications for which finalize requests are not received by the frontend data service within the timeout period are aborted by the service.
4. At box 1125, finalize one or more snapshots (in accordance with the finalize requests) to ensure that corresponding indexes have been generated and stored (committed) to the object store. These snapshots are now accessible from the object store using the indexes.

Thereafter, the migration procedure 1100 continues as follows:
6. At box 1135, terminate the (local) LTSS instance at (or proximate) the local (primary) site location.
7. At box 1140, instantiate and start (deploy) the (destination) LTSS instance at the destination (secondary) site location.
7.5 At box 1142, delete/clean up (remove by garbage collection) aborted snapshot transfers. In an embodiment, delete/cleanup of the aborted snapshot transfers may be performed subsequent (and asynchronous) to migration, e.g., after failover to the destination site.
8. At box 1145, rebuild (recover) service state of the destination LTSS instance from the object store to determine all committed snapshots.
9. At box 1150, the service migration procedure ends.

In an embodiment, marking of the LTSS service 1000 includes assertion of a marker or flag 1050, e.g., at the LTSS instance 1000, that prevents (ceases) generation of new snapshots at the CVM 300, e.g., the asserted flag 1050 indicates that the LTSS notifies the client to not start any new generation of the snapshots. Upon assertion of the flag 1050, the local LTSS instance waits for pending (on-going) in-flight data replication transfers to complete, logs (stores) the completed replicated snapshot data as data objects in the object store, and finalizes (commits) the snapshots in the object store by constructing and storing indexes associated with the snapshots in the object store. The local LTSS instance thereafter shuts down and instantiates (re-deploys) at the secondary (destination) site, e.g., as a destination LTSS instance. The instantiated destination LTSS instance (service) may then recover its service state from the object store (e.g., using the stored up-to-date snapshot data and metadata) to determine all committed snapshots. Lastly, the destination LTSS instance may de-assert the flag 1050 and notifies the client that it may resume new replication of snapshots to the LTSS instance at the destination site location. Note that any previously aborted snapshot replications may not be resumed from a point of cessation, but rather must be restarted from the beginning.

In an embodiment, assertion of the flag 1050 allows a configurable period of time (timeout period) for inflight snapshot replication transfers to complete and for the replicated snapshots to be finalized. After the time period lapses (expires), any pending inflight transfers are aborted and may be restarted (e.g., from the beginning) after LTSS service migration and instantiation has occurred at the destination site. Illustratively, the configurable (predetermined) period of time may be set at (equal to or approximate) an RPO (e.g., one hour). Once the flag 1050 is de-asserted, the client may initiate further snapshot replication transactions to the newly instantiated LTSS instance at the destination site either by replicating snapshots of a new logical entity (e.g., a new UVM and/or vdisk) or resuming replication for an existing logical entity (e.g., an existing UVM and/or vdisk). Note that the marking aspect of the service migration technique (e.g., assertion/de-assertion of the flag) may be implemented in accordance with a recovery plan associated with a planned failover event.

Advantageously, the technique described herein is directed to migration of a LTSS service as opposed to migration of a workload, which is typical in a DR environment. The migration and instantiation of the LTSS service is a notable aspect of the technique because the service is configured to construct and manage indexes needed to locate and access snapshot data and metadata in an object store.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software encoded on a tangible (non-transitory) computer-readable medium (e.g., disks and/or electronic memory) having program instructions executing on a computer system, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
receiving one or more replicated snapshots at an instance of a snapshot storage service for storage and retrieval of snapshots, the snapshot storage service instance executing on a computing node proximate a primary site, the snapshots replicated in accordance with snapshot replication transfers of a replication transaction from a client;
marking the snapshot storage service instance to reject generation of new snapshots;
finalizing the snapshots by completing index data structures configured to identify locations of the snapshots on an object store, wherein finalizing includes storing snapshot data and metadata as a service state of the snapshots committed to the object store;
terminating the snapshot storage service instance proximate the primary site;
instantiating another instance of the snapshot storage service at a secondary site; and
rebuilding the service state of the another snapshot storage service instance from the object store and resume storage and retrieval operations of the snapshots serviced by the another snapshot storage instance.

2. The method of claim 1 further comprising, in response to marking the snapshot storage service instance, waiting for inflight snapshot replication transfers to complete and finalize.

3. The method of claim 1 further comprising, in response to marking the snapshot storage service instance, aborting inflight snapshot replication transfers after elapse of a configurable period of time.

4. The method of claim 3 wherein the configurable period of time approximates a recovery point objective.

5. The method of claim 1 wherein marking of the snapshot storage service instance comprises asserting a flag that indicates to the snapshot storage service instance to notify the client to cease generation of new snapshots.

6. The method of claim 5 further comprising de-asserting the flag to notify the client to resume replication of the snapshots to the another snapshot storage service instance at the secondary site.

7. The method of claim 5 further comprising de-asserting the flag to notify the client to initiate further snapshot replication transactions to the another snapshot storage service instance at the secondary site.

8. The method of claim 1 further comprising determining committed snapshots during the rebuild of the another snapshot storage service.

9. The method of claim 3 further comprising deleting by garbage collection aborted inflight replicated data.

10. A non-transitory computer readable medium including program instructions for execution on a processor of a node, the program instructions configured to:
receive one or more replicated snapshots at an instance of a snapshot storage service for storage and retrieval of snapshots, the snapshot storage service instance executing on a computing node proximate a primary site, the snapshots replicated in accordance with snapshot replication transfers of a replication transaction from a client;
mark the snapshot storage service instance to reject generation of new snapshots;
finalize the snapshots by completing index data structures configured to identify locations of the snapshots on an object store, wherein finalizing includes storing snapshot data and metadata as a service state of the snapshots committed to the object store;
terminate the snapshot storage service instance proximate the primary site;
instantiate another instance of the snapshot storage service at a secondary site; and
rebuild the service state of the another snapshot storage service instance from the object store and resume storage and retrieval operations of the snapshots serviced by the another snapshot storage instance.

11. The non-transitory computer readable medium of claim 10, wherein the program instructions are further configured to, in response to the program instructions configured to mark the snapshot storage service instance, wait for inflight snapshot replication transfers to complete and finalize.

12. The non-transitory computer readable medium of claim 10, wherein the program instructions are further configured to, in response to the program instructions configured to mark the snapshot storage service instance, abort inflight snapshot replication transfers after elapse of a configurable period of time.

13. The non-transitory computer readable medium of claim 12, wherein the configurable period of time is set at a recovery point objective.

14. The non-transitory computer readable medium of claim 10, wherein the program instructions configured to mark the snapshot storage service instance are further configured to assert a flag that indicates to the snapshot storage service instance to notify client to cease generation of new snapshots.

15. The non-transitory computer readable medium of claim 14, wherein the program instructions are further configured to de-assert the flag to notify the client to resume replication of the snapshots to the another snapshot storage service instance at the secondary site.

16. The non-transitory computer readable medium of claim 14, wherein the program instructions are further configured to de-assert the flag to notify the client to initiate further snapshot replication transactions to the another snapshot storage service instance at the secondary site.

17. The non-transitory computer readable medium of claim 10, wherein the program instructions are further configured to determine committed snapshots during the rebuild of the another snapshot storage service.

18. The non-transitory computer readable medium of claim 10, wherein the program instructions are further configured to delete by garbage collection aborted inflight replicated data.

19. An apparatus comprising:
a computer node having a processor configured to execute program instructions configured to:
receive one or more replicated snapshots at an instance of a snapshot storage service for storage and retrieval of snapshots proximate a primary site, the snapshots replicated in accordance with snapshot replication transfers of a replication transaction from a client;
mark the snapshot storage service instance to reject generation of new snapshots;
finalize the snapshots with index data structures configured to identify locations of the snapshots on an object store, wherein finalizing includes storing snapshot data and metadata as a service state of the snapshots committed to the object store;
terminate the snapshot storage service instance proximate the primary site;
instantiate another instance of the snapshot storage service at a secondary site; and
rebuild the service state of the another snapshot storage service instance from the object store and resume storage and retrieval operations of the snapshots serviced by the another snapshot storage instance.

20. The apparatus of claim 19, wherein the program instructions are further configured to, in response to the program instructions configured to mark the snapshot storage service instance, wait for inflight snapshot replication transfers to complete and finalize.

21. The apparatus claim 19, wherein the program instructions are further configured to, in response to the program instructions configured to mark the snapshot storage service instance, abort inflight snapshot replication transfers after elapse of a configurable period of time.

22. The apparatus of claim 21, wherein the configurable period of time is equal to a recovery point objective.

23. The apparatus of claim 19, wherein the program instructions configured to mark the snapshot storage service instance are further configured to assert a flag that indicates to the snapshot storage service instance to notify client to cease generation of new snapshots.

24. The apparatus of claim 23, wherein the program instructions are further configured to de-assert the flag to notify the client to resume replication of the snapshots to the another snapshot storage service instance at the secondary site.

25. The apparatus of claim 23, wherein the program instructions are further configured to de-assert the flag to notify the client to initiate further snapshot replication transactions to the another snapshot storage service instance at the secondary site.

26. The apparatus of claim 19, wherein the program instructions are further configured to determine committed snapshots during the rebuild of the another snapshot storage service.

27. The apparatus of claim 19, wherein the program instructions are further configured to delete by garbage collection aborted inflight replicated data.
